(19) United States
(12) Patent Application Publication
(10) Pub. No.: US 2016/0057105 A1
(43) Pub. Date: Feb. 25, 2016

(54) RELAY DEVICE, METHOD FOR SELECTING COMMUNICATION METHOD, AND PROGRAM

(71) Applicant: MITSUBISHI ELECTRIC CORPORATION, Tokyo (JP)

(72) Inventor: Mamoru KATO, Tokyo (JP)

(73) Assignee: MITSUBISHI ELECTRIC CORPORATION, Tokyo (JP)

(21) Appl. No.: 14/779,439

(22) PCT Filed: May 23, 2013
(86) PCT No.: PCT/JP2013/064307

§ 371 Date: Sep. 23, 2015

(51) Int. Cl. H04L 29/12; H04L 25/20; H04L 29/06

(52) U.S. Cl. CPC H04L 61/2535; H04L 61/2592; H04L 63/0272; H04L 25/20

(57) ABSTRACT

A connection setting server part 170 receives, from one terminal, address notifying information that notifies, as a communication address of a registration target terminal, either of a communication address of the one terminal and a communication address of another terminal belonging to the same network segment with the one terminal. An address checking part 150 checks, based on the communication address of the registration target terminal and a communication address of a VPN GW 11, whether or not the registration target terminal belongs to the same network segment with the VPN GW 11. A connection method setting part 160 selects, based on the checking result by the address checking part 150, a communication method between the registration target terminal and an external network from a plurality of communication methods.

### TECHNICAL FIELD

The present invention relates to a method for selecting a communication method from a plurality of communication methods for a communication device within an internal network to communicate with an external network.

### BACKGROUND ART

In a case where sites are connected by a VPN (Virtual Private Network), it is necessary to design a network so as to avoid collision of IP (Internet Protocol) addresses among the sites.

However, when a plurality of sites that operate respectively using independent private IP addresses are connected by the VPN, the collision of the IP addresses between the sites might occur.

In order to avoid such an inconvenience, there is a method of address conversion which manages a virtual IP address that is unique on the VPN, and performs an address conversion using a NAT (Network Address Translation) (Non-Patent Literature 1) at VPN GW (GateWay) devices (referred to as a VPN GW, hereinafter) or relay centers of the sites.

An operation of a VPN GW that performs address conversion by NAT will be explained.

For instance, it is assumed that a terminal 1 (IP address: 192.168.1.2) of a certain site 1 accesses a terminal 2 (IP address: 192.168.1.3) of a site 2.

Since the site 1 and the site 2 have the same network addresses (192.168.1.0/24), if the terminal 1 of the site 1 communicates with the terminal 2 of the site 2 without address conversion, the addresses collide, which prevents correct routing.

Accordingly, the VPN GW 1 of the site 1 and the VPN GW 2 of the site 2 respectively specify terminals of another site using a virtual IP address.

For instance, the VPN GW 2 of the site 2 specifies a virtual IP address of the terminal 1 as 10.10.10.2, and the VPN GW 1 of the site 1 specifies a virtual IP address of the terminal 2 as 10.10.20.3.

Then, the terminal 1 specifies the virtual IP address of the terminal 2 as a destination address and sends a packet, the VPN GW 1 and the VPN GW 2 perform an address conversion between the virtual IP address and the real IP address in a way described below, thereby avoiding the collision of the private IP addresses.

### 1) Terminal 1→the VPN GW 1:

Sender: IP address (192.168.1.2) belonging to the site 1 of the terminal 1

Destination: the virtual IP address of the terminal 2 (10.10.20.3)

### 2) VPN GW 1→the VPN GW 2:

Sender: the virtual IP address of the terminal 1 (10.10.10.2)

Destination: the virtual IP address of the terminal 2 (10.10.20.3)

3) VPN GW 2→the terminal 2:

Sender: the virtual IP address of the terminal 1 (10.10.10.2)

Destination: the IP address (192.168.1.3) belonging to the site 2 of the terminal 2

### CITATION LIST

### Non-Patent Literature

Non-Patent Literature 1: RFC2663: IP Network Address Translator (NAT) Terminology and Considerations

### SUMMARY OF INVENTION

### Technical Problem

In the NAT method mentioned above, when the terminal connected to the VPN and the VPN GW are in the same network segment, the terminal can route the communication packet in which the virtual IP address is described to the VPN GW.

For instance, in the above example, if the IP address of the VPN GW 1 is 192.168.1.100, the terminal can route the packet in which the virtual IP address is specified to the VPN GW by specifying the VPN GW as a default gateway.

On the other hand, when the network segments of the VPN GW and the terminal are different, for instance, if the IP address of the terminal 1 is 192.168.2.2, the terminal cannot specify the VPN GW as the default gateway.

Accordingly, there is a problem that a packet in which the virtual IP address is described is not routable to the VPN GW.

Therefore, in a case where a plurality of network segments exist within the site, changes on the settings of the existing routers are needed, which makes introducing the VPN very laborious.

For solving the above problem, there is a method where the tunneling connection is carried out from the terminal within the site to the VPN GW and a packet in which the virtual IP address is described flows in the tunnel.

The tunneling protocol, for instance, includes RFC 2637: PPTP (Point-to-Point Tunneling Protocol).

A description will be given to the operation of the terminal and the VPN GW which carry out connection according to the tunneling method in the site.

For instance, if the IP address of the terminal 1 of the site 1 is 192.168.2.2, the tunneling connection from the terminal 1 to the VPN GW 1 (the IP address 192.168.1.100) is carried out.

When the terminal 1 accesses the terminal 2 of the site 2, the terminal 1 may send a packet in which the tunnel processing (the encapsulation processing) is made to the virtual IP address of the terminal 2 to the VPN GW 1.

There is a problem that the communication method which uses only NAT is only applicable to the terminal that is in the network segment in which the VPN GW is. There is another problem that the communication method using only the tunneling method cannot achieve the VPN connection of the terminal which does not have the tunneling connection function (such as Non-PC (Personal Computer) device, etc. like a sequencer).

In the communication method using both of the NAT method and the tunneling method, when the VPN GW registers the terminals within the site, it is necessary for the user to select a relay method for carrying out the VPN connection according to the relation between the terminal and the VPN GW within the network and to set the selected connection method.

Therefore, there is a problem that setting of the VPN GW requires advanced knowledge about networks, therefore, a deployment of the VPN GW does not progress smoothly.

The main object of the present invention is to solve the above problems.

More specifically, the present invention mainly aims to obtain a configuration which selects an appropriate communication method from among a plurality of communication methods without placing a burden on the user.

### Solution to Problem

According to the present invention, relay device which belongs to a network segment of an internal network that is divided into a plurality of network segments, and relays communication between the internal network and an external network being outside the internal network by conforming to a communication method selected from a plurality of communication methods, the relay device includes:

an address notifying information receiving part to receive address notifying information, from one communication device belonging to the internal network, that notifies either of a communication address of the one communication device and a communication address of another communication device belonging to the internal network as a communication address of a selection target communication device that is a selection target of a communication method;

a segment checking part to check, based on the communication address of the selection target communication device and the communication address of the relay device, whether or not the selection target communication device belongs to a network segment being same with the relay device; and

a communication method selecting part to select, based on a checking result by the segment checking part, a communication method between the selection target communication device and the external network from the plurality of communication methods.

### Advantageous Effects of Invention

The relay device according to the present invention checks whether or not the selection target communication device belongs to a sub-network which is the same with the relay device, and based on the checking result, selects a communication method between the selection target communication device and the external network.

Accordingly, the present invention can selects an appropriate communication method without placing a burden on the user.

### BRIEF DESCRIPTION OF DRAWINGS

FIG. 1 is a diagram illustrating a configuration example of a VPN system according to a first embodiment.

FIG. 2 is a diagram illustrating a configuration example of a VPN GW according to the first embodiment.

FIG. 3 is a diagram illustrating a configuration example of a VPN server according to the first embodiment.

FIG. 4 is a diagram illustrating setting examples of a NAT method, a tunneling method, and a NAPT method according to the first embodiment.

FIG. 5 is a diagram illustrating an example of a terminal registration screen according to the first embodiment.

FIG. 6 is a diagram illustrating an example of setting result information according to the first embodiment.

FIG. 7 is a flowchart illustrating an operation example of the VPN GW according to the first embodiment.

FIG. 8 is a diagram illustrating a configuration example of hardware of the VPN GW according to the first embodiment.

### DESCRIPTION OF EMBODIMENTS

### Embodiment 1

In the following, an embodiment of a VPN system according to the present invention will be explained.

The following embodiment merely illustrates an example of the present invention, and does not specify any concrete configuration.

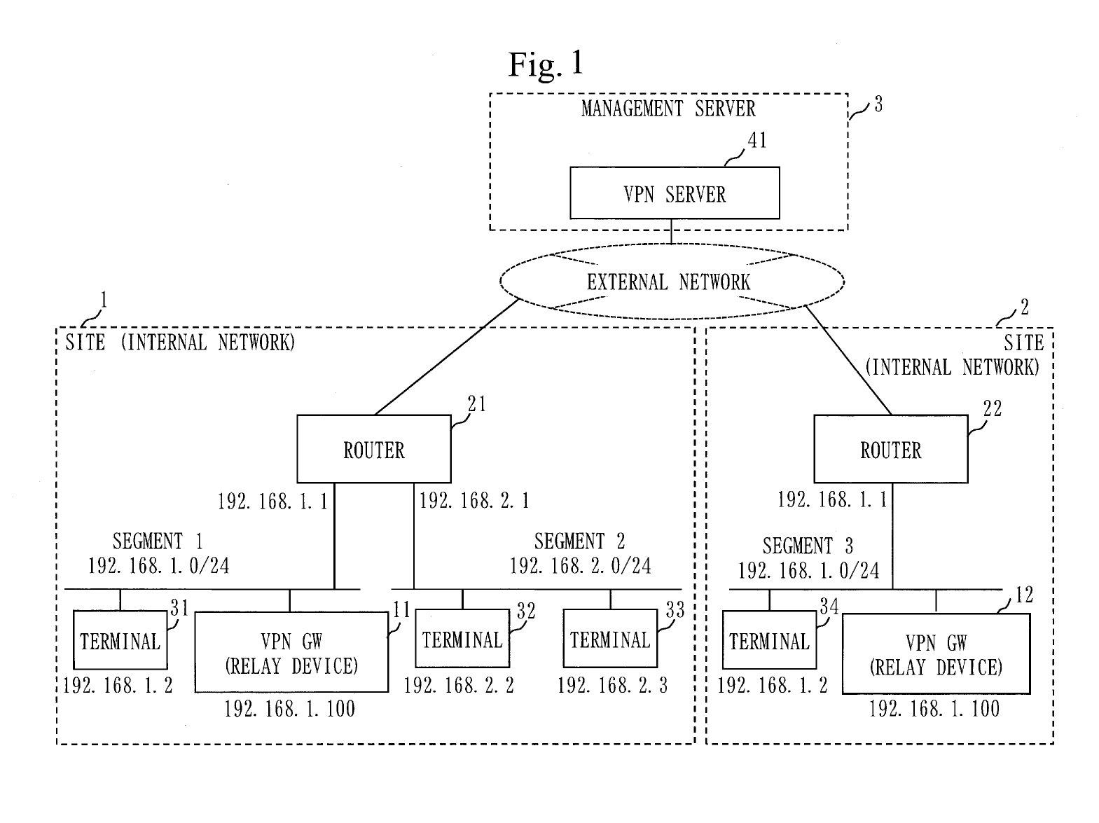

FIG. 1 illustrates a configuration example of a VPN system according to the present embodiment.

In FIG. 1, a VPN connection is carried out between a site 1 and a site 2 via an external network and a management server 3.

Each of a network within the site 1 and a network within the site 2 is also referred to as an internal network.

A router 21 of the site 1, a router 22 of the site 2, and a VPN server 41 of the management server 3 are connected to the external network.

For the external network, wired or wireless Internet can be used.

Here, although the illustration is omitted in FIG. 1, a firewall or a proxy server may be arranged at the connection part between the external network and the internal network.

Further, a plurality of routers can be connected in cascade.

A private network (internal network) of the site 1 is divided into a network segment 1 (192.168.1.0/24) and a network segment 2 (192.168.2.0/24).

Then, the network segment 1 and the network segment 2 are connected to the external network via the router 21.

To the network segment 1, the VPN GW 11 and the terminal 31 are connected, and to the network segment 2, the terminal 32 and the terminal 33 are connected. In the private network of the site 2, a network segment 3 (192.168.1.0/24) is connected to the external network via a router 22.

To the network segment 3, the VPN GW 12 and the terminal 34 are connected.

The VPN GW 11 and the VPN GW 12 are virtual network management apparatuses.

The VPN GW 11 and the VPN GW 12 carry out the VPN connection with the VPN server 41.

The terminals 31 to 34 are computing devices which include a user interface, for instance, a PC, a server, a tablet, a smartphone, and the like.

Further, the terminals 31 to 34 may be network connection devices including a sequencer, a manufacturing apparatus, an electric power measurement device, and the like.

The VPN GW 11 and the VPN GW 12 select a communication method between the terminal within the site and the external network from a plurality of communication methods.

Further, the VPN GW 11 and the VPN GW 12 relay the communication between the terminal within the site and the external network by conforming to the selected communication method.

Here, the VPN GW 11 and the VPN GW 12 correspond to examples of a relay device.

Further, the terminals 31 to 34 correspond to examples of a communication device.

For the network segment 1 of the site 1 and the network segment 3 of the site 2, the same network addresses 192.168.1.0/24 are used.

Accordingly, there might be a case, the communication cannot be implemented because of the overlap of the IP addresses if the sites are connected using the real IP addresses by the VPN.

For instance, the IP addresses of the terminal 31 and the terminal 34 are overlapped.

Therefore, on the VPN between the VPN GW to the VPN server to the VPN GW, each terminal uses a virtual IP address with which each terminal is uniquely identified.

The following will explain a case where the management and the allocation of the virtual IP address are centrally administrated by the VPN server 41.

However, another configuration can be formed so that each VPN GW manages and allocates the virtual IP addresses.

In the present embodiment, the following virtual IP addresses are assumed.

The network address of the site 1 is assumed to be 10.10.10.0/24.

The network address of the site 2 is assumed to be 10.10.20.0/24.

The virtual IP address of the terminal 31 is assumed to be 10.10.10.2.

The virtual IP address of the terminal 32 is assumed to be 10.10.10.3.

The virtual IP address of the terminal 33 is assumed to be 10.10.10.4.

The virtual IP address of the terminal 34 is assumed to be 10.10.20.2.

The VPN GW 11 receives the communication packet having the virtual IP address corresponding to the site 2 from the terminal registered in the site 1.

Then, the VPN GW 11 transfers the communication packet to the VPN server 41 through the VPN tunnel between the VPN GW 11 and the VPN server 41.

The VPN server 41 carries out routing to the site 2 based on the virtual IP address of the communication packet.

Then, the VPN server 41 sends the communication packet to the VPN GW 12 through the VPN tunnel between the VPN server 41 and the VPN GW 12.

The VPN GW 12 sends the received communication packet to the terminal within the corresponding site 2.

As discussed above, even if the private IP addresses are overlapped between the sites, the communication between the sites is enabled.

Further, the management server 3 relays the communication data of the VPN in the present embodiment; however, the configuration can be another in which the management server only manages the connection between the sites and a peer-to-peer communication between the site 1 and the site 2 is carried out without through the management server 3.

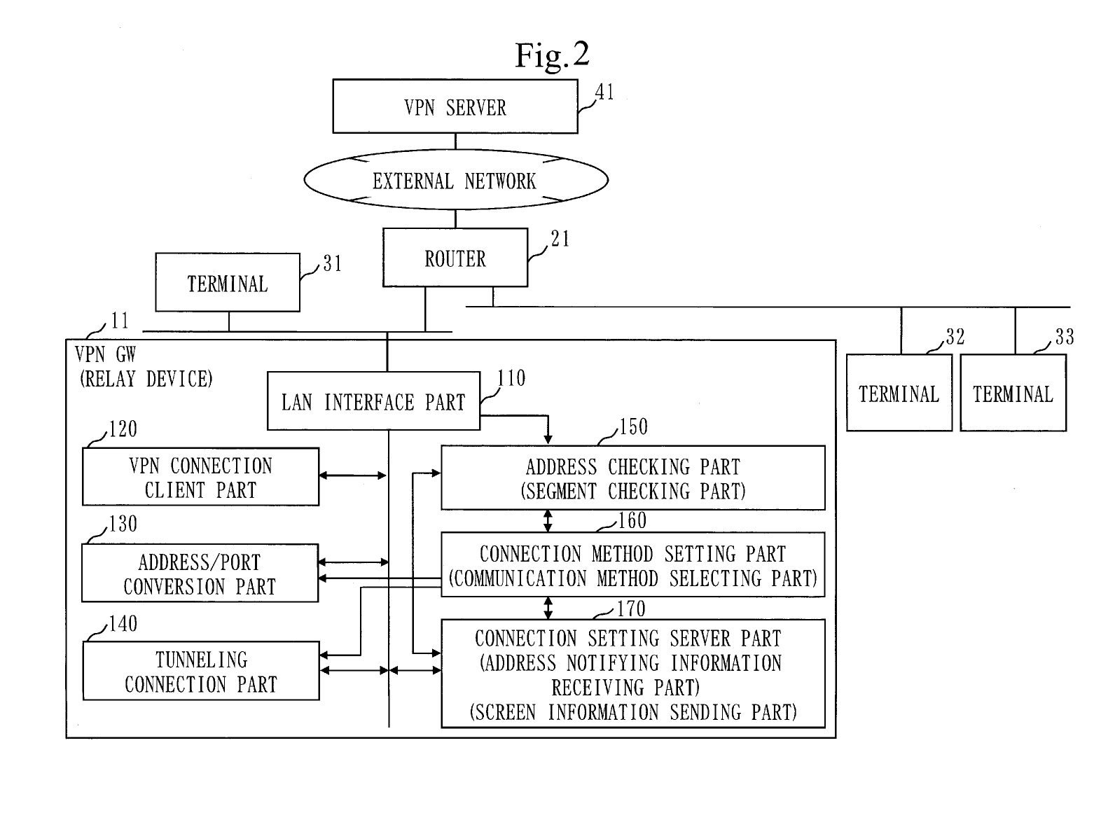

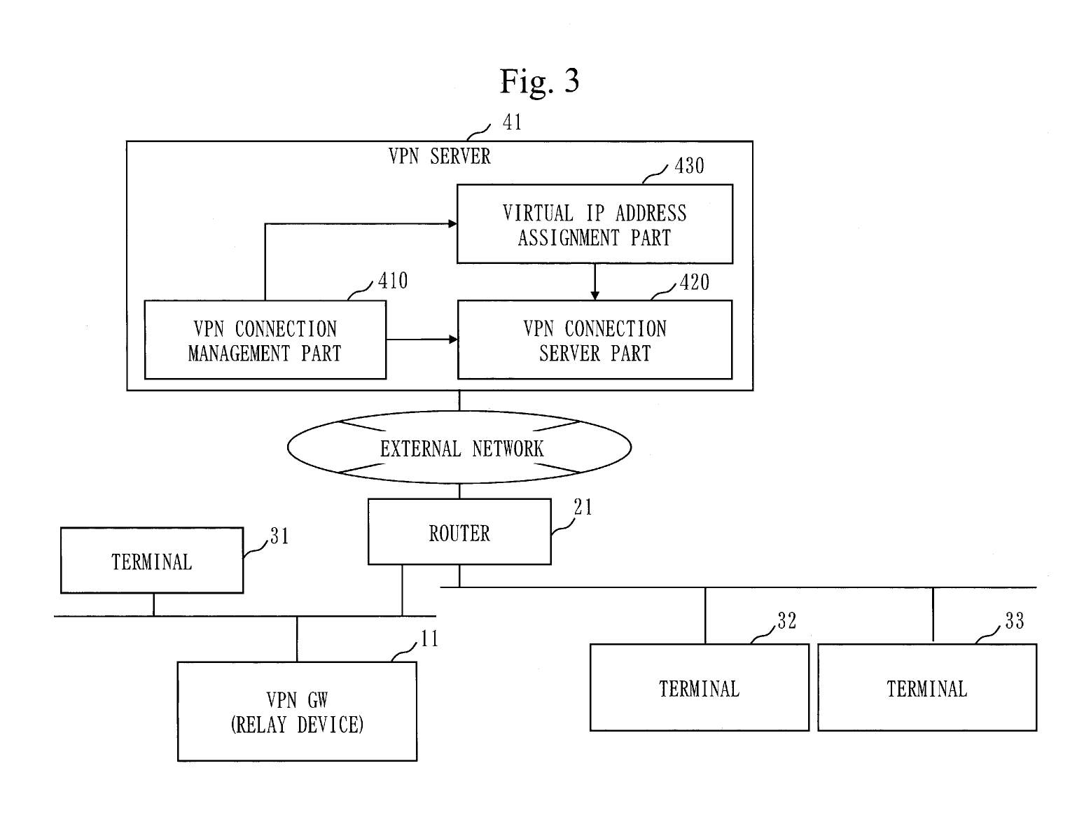

Next, with reference to FIGS. 2 and 3, detailed explanation of the VPN GW 11 and the VPN server 41 will be carried out.

Here, since the VPN GW 12 has the same configuration as the VPN GW 11, the explanation will be omitted.

As illustrated in FIG. 2, the VPN GW 11 is connected to the private network in the site via a LAN (Local Area Network) interface part 110.

Further, the VPN GW 11 includes a VPN connection client part 120, an address/port conversion part 130, a tunneling connection part 140, an address checking part 150, a connection method setting part 160, and a connection setting server part 170.

As illustrated in FIG. 3, the VPN server 41 includes a VPN connection management part 410, a VPN connection server part 420, and a virtual IP address assignment part 430.

In the VPN GW 11, the LAN interface part 110 may be, as discussed above, an interface adapted to the wired LAN or the interface adapted to the wireless LAN.

In a case where the VPN GW 11 is connected to the wired LAN, for instance, the interface for Ethernet (registered trademark) can be used for the LAN interface part 110.

Further, although FIG. 2 illustrates one LAN interface part, the VPN GW 11 can be provided with two or more LAN interfaces.

For instance, the configuration can include a LAN interface for connecting to the VPN and a LAN interface for connecting to the terminal within the site.

The VPN connection client part 120 establishes the VPN tunnel between the VPN connection client part 120 and the VPN connection server part 420.

The VPN tunnel can be established using the known VPN software or hardware.

The present embodiment will explain using an example in which the VPN tunnel is established by Open VPN.

Prior to the VPN connection, the administrator of the VPN GW 11 accesses the VPN connection management part 410 of the VPN server 41 and registers information on the VPN GW 11 and the VPN connection terminal within the site.

The VPN connection management part 410 is implemented by, for instance, the Web application and the like.

The administrator of the VPN GW 11 accesses the VPN connection management part 410 from the terminal within the site using the Web browser or an exclusive client application and registers an identifier of the VPN GW and an IP address of the terminal within the site to be connected to the VPN in the VPN connection management part 410.

The virtual IP address for the registered VPN GW and the virtual IP address for the registered terminal are assigned by the virtual IP address assignment part 430.

Then, the virtual IP addresses assigned by the virtual IP address assignment part 430 are stored in the VPN connection server part 420.

The assignment method of the virtual IP address can be any if, according to such a method, the VPN GW or the terminal to be connected to the same VPN can be uniquely identified.

For instance, as discussed above, a range of the virtual IP addresses that are available to the terminals under the VPN GW can be previously assigned for each VPN GW.

The address/port conversion part 130 of the VPN GW 11 performs the conversion of the IP address and the port number between the communication packet received from the LAN by the LAN interface part 110 and the communication packet received from the VPN by the VPN connection client part 120.

The connection method setting part 160, which will be discussed later, holds setting result information illustrated in FIG. 6.

The setting result information is information in which the real IP address, the virtual IP address, and the connection method (the NAT method, the tunneling method, and the NAPT method) are related with each other.

The address/port conversion part 130 performs, with reference to the setting result information, the conversion of the IP address and the port number.

Here, details of the setting result information will be discussed later.

The conversion of IP address and the port number by the address/port conversion part 130 is performed in accordance with the following rules:

(1) NAT method (the packet received from VPN)

If the destination IP address of the communication packet received by the VPN connection client part 120 matches, in the setting result information, the virtual IP address registered with related to the NAT method, the address/port conversion part 130 converts the destination IP address, which is the virtual IP address, to the corresponding real IP address.

Then, the address/port conversion part 130 sends the communication packet whose address has been converted to the LAN interface part 110.

(2) NAT method (the packet received from the terminal within the site)

If the sender IP address of the communication packet received by the LAN interface part 110 matches, in the setting result information, the real IP address registered with related to the NAT method and the destination IP address matches, in the setting result information, the virtual IP address registered with related to the NAT method, the address/port conversion part 130 converts the sender IP address, which is the real IP address, to the corresponding virtual IP address.

Then, the address/port conversion part 130 sends the communication packet whose address has been converted to the VPN connection client part 120.

(3) NAPT method (the packet received from VPN)

If the destination IP address of the communication packet received by the VPN connection client part 120 matches, in the setting result information, the virtual IP address which is registered with related to the NAPT method, the address/port conversion part 130 converts the destination IP address, which is the virtual IP address, to the corresponding real IP address.

In addition, the address/port conversion part 130 registers the sender IP address, the sender port number, and the port number which is newly obtained in the VPN GW 11 in the conversion table by relating with each other.

Further, the address/port conversion part 130 converts the sender IP address to the IP address within the site of the VPN GW 11, and the sender port number to the newly obtained port number.

Then, the address/port conversion part 130 sends the communication packet whose address and port number have been converted to the LAN interface part 110.

(4) NAPT method (the packet received from the terminal within the site)

If the sender IP address of the communication packet received by the LAN interface part 110 matches, in the setting result information, the real IP address which is registered with related to the NAPT method, the address/port conversion part 130 converts the sender IP address, which is the real IP address, to the corresponding virtual IP address.

Further, the address/port conversion part 130 searches, based on the destination port number, the conversion table of (3), and sets the sender IP address and the sender port number of the matched record to the destination IP address and the destination port number, respectively.

Then, the address/port conversion part 130 sends the communication packet whose address and port number have been converted to the VPN connection client part 120.

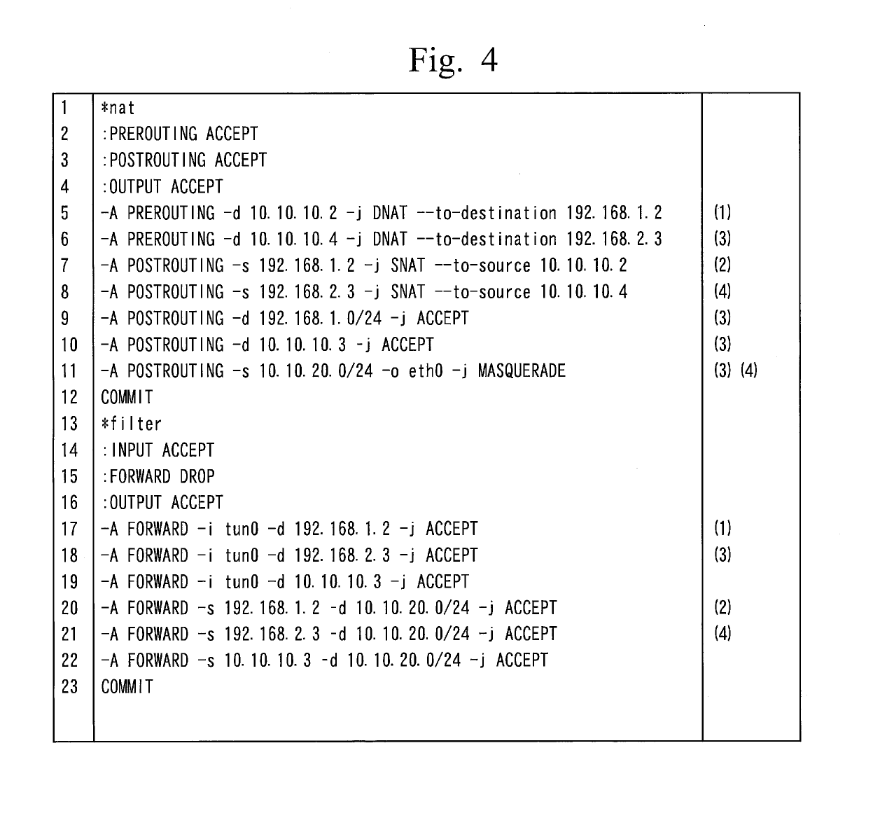

FIG. 4 illustrates a setting example for converting the IP address and the port number by the address/port conversion part 130.

FIG. 4 illustrates a setting example when iptables mounted on Linux (registered trademark) OS (Operating System) is used.

In the example of FIG. 4, the address described in the communication packet whose destination is the terminal 31 of the site 1 and the address described in the communication packet from the terminal 31 of the site 1 are converted by the NAT method.

Specifically, the 5th line and the 17th line of FIG. 4 describe the setting of the conversion of the above (1) NAT method (the packet received from VPN). The virtual IP address defined in the setting example of FIG. 4 is 10.10.10.2, and the real IP address is 192.168.1.2.

Further, the 7th line and the 20th line describe the setting of the conversion of the above (2) NAT method (the packet received from the terminal within the site).

The virtual IP address defined as the destination IP address is 10.10.20.0/24 which is the range of the virtual IP address of the site 2.

Further, in the example of FIG. 4, the address and the port number described in the communication packet which is destined to the terminal 33 of the site 1 and the address and the port number described in the communication packet from the terminal 33 of the site 1 are converted by the NAPT method.

Specifically, in the 6th, the 9th, the 10th, the 11th, and the 18th lines, the setting of the conversion of the above (3) NAPT method (the packet received from VPN) is described.

Here, two steps are carried out so as to check whether or not the destination IP address matches the virtual IP address which is registered with related to the NAPT method.

First, if the destination IP address matches the virtual IP address defined in the 6th line, the destination IP address is converted to the real IP address described in the 6th line.

Then, in the 9th and the 10th lines, if the real IP address after conversion matches the IP address which does not use the NAPT method (in this case, the address of the segment 1 and the virtual IP address of the terminal 32 that is 10.10.10.3), it is determined that the NAPT method is not used for the communication packet including the destination IP address which is currently targeted.

Other than that, that is, if the real IP address after conversion matches the IP address using the NAPT method, the process proceeds to the 11th line, and the IP address and the port of the sender are converted.

In the 11th line, if the sender IP address is the virtual IP address of the site being different from the site 1 (in this case, 10.10.20.0/24 that is the range of the virtual IP address of the site 2), and the destination IP address is the address to be transferred to the LAN interface part 110, the IP address and the port of the sender are converted by the NAPT method. Associating the IP address and the port number of the sender before conversion and the port number after conversion with each other is managed by iptables.

The virtual IP address described in the 6th line is 10.10.10.4, and the real IP address is 192.168.2.3.

Further, in the 8th, the 11th and the 21st lines, the setting of the conversion of the above (4) NAPT method (the packet received from the terminal within the site) is carried out.

First, in the 11th line, an inverse conversion of the above (3) is performed. That is, if the destination IP address and the port number match the sender IP address and the port number after conversion of the above (3), the destination IP address and the port number are converted to the IP address and the port number of the sender before conversion of the above (3). In the 8th and the 21st lines, the setting of the conversion of the sender IP address is described. If the sender IP address is the real IP address 192.168.2.3, and the destination IP address is 10.10.20.0/24 which is the range of the virtual IP address of the site 2, the sender IP address is converted to the virtual IP address 10.10.10.4.

Here, the 10th, the 19th and the 22nd lines represent setting examples of a case where the terminal 32 uses the tunneling method.

Namely, the 10th, the 19th and the 22nd lines represent settings according to which only transfer of the communication packet is executed between the tunneling connection part 140 and the VPN connection client part 120 without the address conversion.

Further, in FIG. 4, eth0 represents a name of the interface of the LAN interface part 110.

Further, tun0 represents a name of the interface of the VPN connection client part 120.

The setting of FIG. 4 merely illustrates an example, and it is clear for those skilled in the art to implement an equivalent configuration by another setting. To the setting of FIG. 4, the address and the connection method described in the setting result information generated by the connection method setting part 160 are reflected.

Receiving the tunneling connection request from the terminal within the site, the tunneling connection part 140 establishes the tunneling connection between the terminal within the site and the tunneling connection part 140.

The tunneling connection part 140 sends to the VPN connection client part 120 the packet received through the tunnel.

Further, if the destination IP address of the packet received by the VPN connection client part 120 matches the virtual IP address registered with related to the tunneling method in the setting result information, the tunneling connection part 140 sends the packet to the tunnel corresponding to the virtual IP address.

For the tunneling connection part 140, a PPTP (Point-to-Point Tunneling Protocol) server and the like can be used.

The PPTP server can be implemented by pptpd software which operates on Linux (registered trademark) OS.

Here, since the tunneling connection is for the communication within the site, encryption of the data is unnecessary.

The processing amount of the VPN GW can be reduced by eliminating the encryption.

For the connection from the terminal 32 to the PPTP server, in a case of Windows (registered trademark) OS, the function of the Internet connection (VPN) which is accompanied to the OS as standard function can be used.

The connection setting server part 170 is, for instance, implemented by the Web application and the like.

The connection setting server part 170 performs the registration of the IP address and the setting on the connection method of the terminal within the site to be connected to the VPN.

The user operates the Web browser or the exclusive client application in the terminal within the site, and requests the VPN connection management part 410 or the connection setting server part 170 to register the IP address. The VPN connection management part 410 or the connection setting server part 170 performs the registration of the IP address and the setting on the connection method.

For instance, as described below, there are two methods for synchronizing the registration of the IP address between the VPN connection management part 410 and the connection setting server part 170.

The first method is that a plurality of IP addresses which the VPN connection management part 410 registers are distributed to the VPN GW, and the connection setting server part 170 registers the plurality of the IP addresses.

The second method is that the plurality of IP addresses registered by the connection setting server part 170 are uploaded to the VPN connection management part 410, and the VPN connection management part 410 registers the plurality of IP addresses.

Further, the connection setting server part 170 is accessed from the terminal within the site, and receives an instruction to register the terminal which is newly connected to the VPN.

The connection setting server part 170 sends, for instance, screen information (Web screen) to enter the IP address to the terminal which executes the registration operation (also referred to as a registration executing terminal, hereinafter).

Then, the user inputs the IP address of the terminal of registration target (the selection target communication device) in a text input box for inputting the IP address on the Web screen displayed on the registration executing terminal.

Or, the user selects the IP address of the terminal of registration target (the selection target communication device) from a list of the IP addresses of the registration target candidates on the Web screen displayed on the registration executing terminal using a checkbox, etc.

The user can set the IP address of the terminal other than the registration executing terminal (the terminal which the user is currently operating) which belongs to the same network segment with the registration executing terminal, for the registration target.

Then, pressing the register button on the Web screen by the user sends information of the IP address of the registration target from the terminal to the VPN GW 11.

Further, the connection setting server part 170 obtains the IP address of the registration executing terminal.

If the connection setting server part 170 is the Web application, the connection setting server part 170 can recognize the IP address of a terminal which has executed a browser by REMOTE_ADDR defined by RFC 3875 (The Common Gateway Interface (CGI) Version 1.1).

Further, for instance, the connection setting server part 170 is a servelet by Java (registered trademark), the connection setting server part 170 can recognize the IP address of a terminal which has executed a browser by using API of getRemoteAddr( )

Also in a case where other execution environment is used, the connection setting server part 170, by the equivalent function, can recognize the IP address of a terminal which has executed a browser.

Here, the connection setting server part 170 corresponds to an example of an address notifying information receiving part and a screen information sending part.

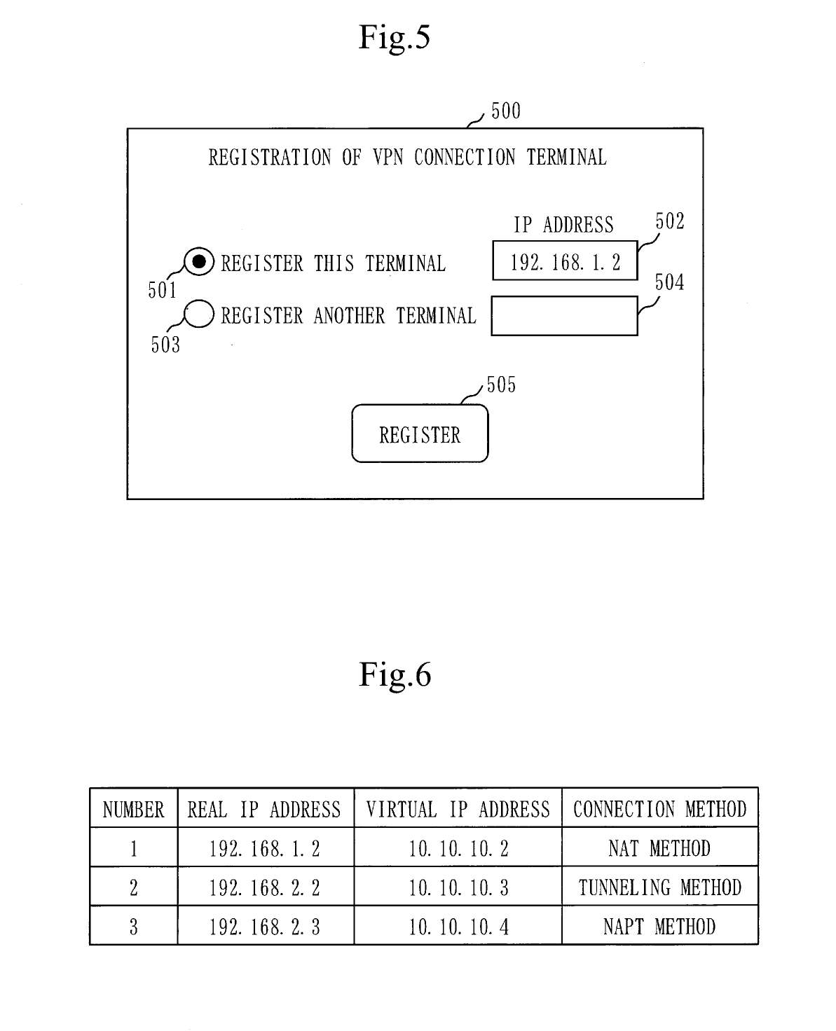

FIG. 5 illustrates an example of the terminal registration screen (Web screen) which the connection setting server part 170 sends to the registration executing terminal.

A terminal registration screen 500 includes a radio button 501, a text box 502, a radio button 503, a text box 504, and a register button 505.

The radio button 501 is a radio button for selecting the registration executing terminal (the terminal 31 in the example of FIG. 5).

The text box 502 is a text box for displaying the IP address of the registration executing terminal.

In a case where the user selects the radio button 501, the IP address of the registration executing terminal obtained by the connection setting server part 170 using the above method is automatically displayed in the text box 502.

Note, alternatively, the user can enter the IP address of the registration executing terminal in the text box 502.

The radio button 503 is a radio button for selecting another terminal which is different from the registration executing terminal.

The text box 504 is a text box for inputting the IP address of the another terminal.

The register button 505 is a button for executing the registration of the IP address.

The user selects, using the screen of FIG. 5 displayed on the terminal, whether the terminal of registration target is the terminal which the user is currently using (registration executing terminal) or another terminal.

Then, if the terminal of registration target is the another terminal, the user enters the IP address of the another terminal in the text box 504.

While the IP address of the registration executing terminal or the IP address of the another terminal is displayed on the text box, if the user presses the register button 505, information notifying the IP address (the IP address of the registration target) within the text box is sent to the connection setting server part 170.

Here, it can be clearly understood by those skilled in the art that, prior to displaying the screen of FIG. 5, security countermeasures such as displaying the log-in screen of the user and the like can be taken.

The address checking part 150 receives information from the user (the selected result of the radio button, the real IP address described in the text box), from the connection setting server part 170.

Further, the address checking part 150 receives the IP address and the netmask of the VPN GW 11 set in the LAN interface part 110 from the connection setting server part 170.

Based on the received information, the address checking part 150 selects one type from the following three Types.

(Type 1) In a case where the IP address of the registration target is an address included in the same network segment with the VPN GW 11:

Example) If the terminal 31 (the IP address: 192.168.1.2) registers the IP address of the terminal 31 itself, the IP address of the terminal 31 is included in the network segment being the same with the VPN GW 11.

(Type 2) In a case where the IP address of the registration executing terminal is the IP address of the registration target, and further, the IP address of the registration target is not included in the network segment being the same with the VPN GW 11:

Example) If the terminal 32 (the IP address: 192.168.2.2) registers the terminal 32 itself, the IP address of the terminal 32 is not included in the network segment being the same with the VPN GW 11.

(Type 3) In a case where the IP address of the registration executing terminal is not the IP address of the registration target, and further, the IP address of the registration target is not included in the network segment being the same with the VPN GW 11:

Example) If the terminal 31 (the IP address: 192.168.1.2) registers the terminal 33 (the IP address: 192.168.2.3), the IP address of the terminal 33 is not included in the network segment being the same with the VPN GW 11.

Here, the address checking part 150 checks whether or not the IP address of the registration target is included in the network segment being the same with the VPN GW 11 (check of Type 1). If the IP address of the registration target is not included in the network segment being the same with the VPN GW 11, the address checking part 150 checks whether or not the IP address of the registration executing terminal equals to the IP address of the registration target (check of Type 2 and Type 3).

The address checking part 150 corresponds to an example of a segment checking part.

The connection method setting part 160 selects, based on the checking result by the address checking part 150, the connection method (the communication method) of the terminal of registration target in the following manner.

Then, the connection method setting part 160 performs the setting of information such as the connection method and the IP address of the registration target terminal and the like to the address/port conversion part 130 or the tunneling connection part 140.

(Type 1) Connection by the NAT method using the address/port conversion part 130
(Type 2) Connection by the tunneling method using the tunneling connection part 140
(Type 3) Connection by the NAPT method using the address/port conversion part 130

Further, the connection method setting part 160 may return the result of the selection to the connection setting server part 170.

In this case, the connection setting server part 170 may display a screen which prompts the user to confirm whether or not the user accepts the connection method selected by the connection setting server part 170.

Further, the connection setting server part 170 may display a screen which prompts the user to enter information which is required additionally (parameters such as a password for the tunneling connection).

Yet further, the connection setting server part 170 may display a screen which notifies the user of the setting method of the registration target terminal.

For instance, the connection setting server part 170 displays, if the NAT method is selected, an execution method of route command to change the setting of the routing of the registration target terminal.

Or, the connection setting server part 170 displays a changing method of the default gateway.

Further, if the tunneling method is selected, the connection setting server part 170 displays a generation method of the tunneling connection of the registration target terminal for each OS.

In addition, not only displaying these methods, the connection setting server part 170 may make the registration target terminal download programs for executing these setting. For instance, if the NAT method is selected, in order to perform the setting of the routing of the registration target terminal, the executable program having the combined contents of the route command and the input parameters (the setting contents of the routing) is downloaded and executed by the user, thereby eliminating the load of inputting laborious command and parameters. Similarly, if the tunneling method is selected, the program to automatically create the tunneling connection of the registration target terminal including the setting contents (the IP address to be connected and the connection parameters and the like) is generated by the connection setting server part 170, downloaded and executed by the user, thereby eliminating the load of laborious generation of the tunneling connection.

If it is determined to be Type 1 by the address checking part 150, since the registration target terminal belongs to the same network segment with the VPN GW 11, the registration target terminal can specify the VPN GW 11 as a default gateway.

Accordingly, the connection method setting part 160 selects the NAT method when the checking result of the address checking part 150 is Type 1. Further, if it is determined to be Type 2 by the address checking part 150, the registration target terminal and the registration executing terminal are the same.

In the present embodiment, the registration executing terminal is assumed to be a PC device.

Accordingly, if it is determined to be Type 2 by the address checking part 150, since the registration target terminal (=the registration executing terminal) is the PC device, an encapsulation process of the communication packet is possible at the registration target terminal, so that the connection method setting part 160 selects the tunneling method.

Further, if it is determined to be Type 3 by the address checking part 150, the registration target terminal is not the same with the registration executing terminal.

In the present embodiment, the registration executing terminal which is the PC device is assumed to perform the registration operation of a non-PC device such as a sequencer and the like.

Accordingly, if it is determined to be Type 3 by the address checking part 150, since the registration target terminal is the non-PC device, the encapsulation process of the communication packet cannot be performed at the registration target terminal, the connection method setting part 160 selects the NAPT method.

The connection method setting part 160 may store, further, the setting result information as a database.

FIG. 6 illustrates an example of a table of the setting result information.

In FIG. 6, numbers are serial numbers of the records of the table.

As illustrated in FIG. 6, in the setting result information, the virtual IP address and the connection method corresponding to the real IP address of the site are recorded by relating them with each other.

The database can be stored by RDBMS (Relational DataBase Management System) or files.

Further, the setting result information may include, as items of the records, attribute items such as a name of the terminal, a registration date, a deregistration date, a status (valid/invalid), a netmask, a gateway, and the like.

Here, the connection method setting part 160 corresponds to an example of a communication method selecting part.

Next, the operation will be explained.

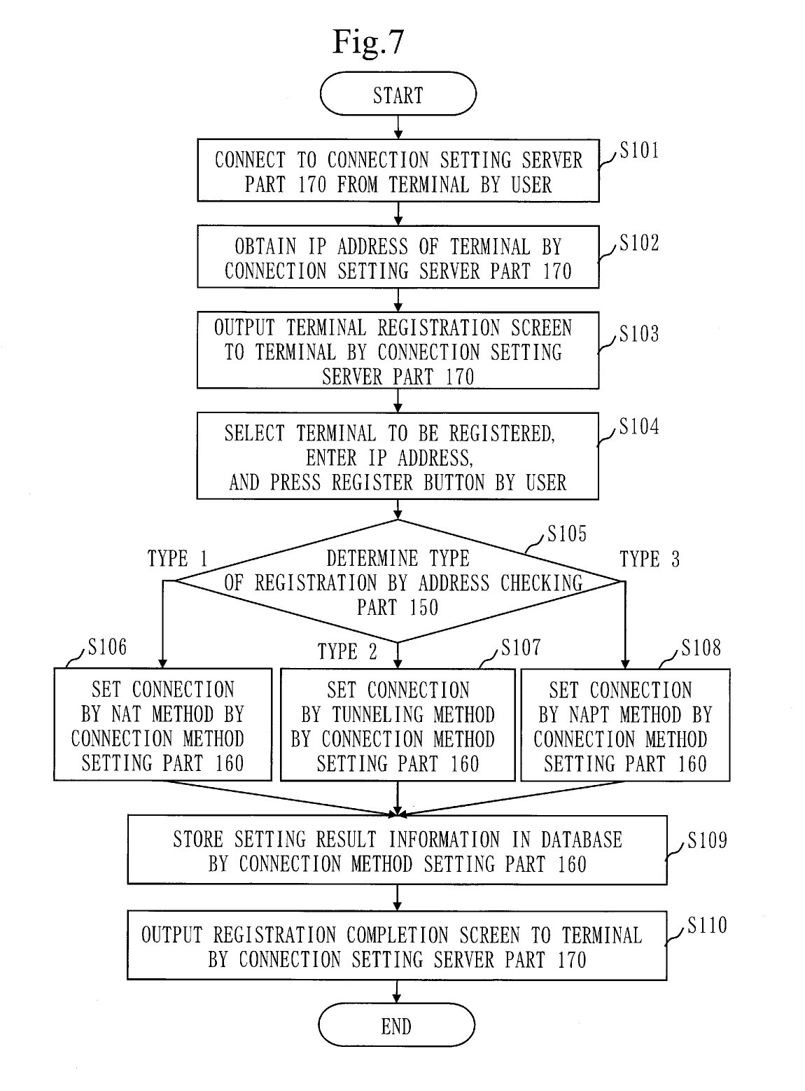

FIG. 7 is a flowchart illustrating the registration setting operation of the VPN connection terminal by the VPN GW 11 according to the present embodiment.

In a case where the user registers a certain terminal in the VPN GW 11 for the VPN connection, the terminal within the site (registration executing terminal) connects to the connection setting server part 170 of the VPN GW 11 using the Web browser or a client application (S101).

At this time, the connection setting server part 170 obtains the real IP address of the registration executing terminal (S102).

Further, the connection setting server part 170 outputs a terminal registration screen (FIG. 5) including the display of the obtained real IP address to the registration executing terminal (S103).

The user selects the terminal of registration target using the radio button 501 or the radio button 503.

In case of selecting the radio button 501, the user presses the register button 505.

In case of registering another terminal which is different from the registration executing terminal, the user enters the real IP address of the registration target terminal (the another terminal) in the text box 504 and presses the register button 505 (S104).

The connection setting server part 170 receives information from the user (the selection result of the radio button and the real IP address described in the text box), and outputs the information from the user and the information on the IP address and the netmask of the VPN GW 11 to the address checking part 150.

The address checking part 150 determines the registration type based on the information from the user and the information on the IP address and the netmask of the VPN GW 11 (S105).

If the checking result of the address checking part 150 is Type 1, the connection method setting part 160 selects the connection by the NAT method, and performs the setting of the connection by the NAT method (S106) (the description of the 5th, the 7th, the 17th, and the 20th lines of FIG. 4 are generated).

If the checking result of the address checking part 150 is Type 2, the connection method setting part 160 selects the connection by the tunneling method, and performs the setting of the connection by the tunneling method (S107) (the description of the 19th and the 22nd lines of FIG. 4 are generated).

If the checking result of the address checking part 150 is Type 3, the connection method setting part 160 selects the connection by the NAPT method, and performs the setting of the connection by the NAPT method (S108) (the description of the 6th, the 8th to the 11th, the 18th, and the 21st lines of FIG. 4 are generated).

Then, the connection method setting part 160 stores the setting result information in the database (S109).

Finally, the connection setting server part 170 outputs a registration completion screen on the registration executing terminal (S110), and the registration is completed.

As discussed above, the VPN GW according to the present embodiment determines the type of the registration using the information on the IP address obtained at the time of registration execution access by the registration executing terminal, on the IP address of the registration target terminal inputted by the user, and on the IP address and the netmask of the VPN GW.

Then, the VPN GW according to the present embodiment can automatically set the connection method suitable to each type.

Accordingly, in case of the network having a plurality of segments, the setting of the VPN connection can be easily performed without considering the configuration of the network by the user.

Hereinbefore, the present embodiment has explained the virtual network management apparatus arranged in the site for connecting a plurality of sites via the VPN.

More specifically, it has been explained the virtual network management apparatus includes:

the connection setting server part which is connected by the registration executing terminal that executes registration when the terminal to be connected to the virtual network is registered, and receives the connection setting of the registration target terminal which is to be connected to the virtual network,

the address checking part which determines the network connection status from the IP address information of the registration executing terminal, the registration target terminal, and the virtual network management apparatus itself,

the first virtual network connection part which connects the registration target terminal to the VPN,

the second virtual network connection part, and

the connection method setting part which selects one of the first virtual network connection part and the second virtual network connection part as the connection method of the registration target terminal based on the checking result of the address checking part, and performs the selection method which is selected.

Further, the present embodiment has explained that the first virtual network connection part is the address/port conversion part which converts the IP address and the port number in the communication packet between the inside of the site and the VPN.

In addition, the present embodiment has explained that the address/port conversion part, as the first address/port conversion method,

for the communication packet from the terminal within the site to the terminal of another site, converts the sender IP address to the virtual IP address on the corresponding VPN, and

for the communication packet from the terminal of the another site to the terminal within the site, converts the destination IP address from the virtual IP address on the VPN to the IP address within the corresponding site.

Further, the present embodiment has explained that the address/port conversion part, as the second address/port conversion method, in addition to the first address/port conversion method,

for the communication packet from the terminal of the another site to the terminal within the site, stores a set of the sender IP address, and a new sender port number of the sender port number, converts the sender IP address to the IP address of the virtual network management apparatus, and converts the sender port number to the new sender port number, and

for the communication packet from the terminal within the site to the terminal of the another site, converts the destination IP address and the destination port number to the sender IP address and the sender port number which have been stored.

Further, the present embodiment has explained that the connection method setting part

if the IP address of the registration target terminal is the address included in the same network segment with the virtual network management apparatus, performs the setting using the first address/port conversion method by the address/port conversion part,

if the IP address of the registration executing terminal is equal to the IP address of the registration target terminal, and further, the IP address of the registration target terminal is the address which is not included in the same network segment with the virtual network management apparatus, performs the setting using the tunneling connection part, and

if the IP address of the registration executing terminal is not equal to the IP address of the registration target terminal, and further the IP address of the registration target terminal is the address which is not included in the same network segment with the virtual network management apparatus, performs the setting using the second address/port conversion method by the address/port conversion part.

Further, the present embodiment has explained that the second virtual network connection part is the tunneling connection part which performs the tunneling connection between the virtual network management apparatus and the terminal within the site.

Then, the tunneling connection part receives the tunneling connection by PPTP, and allocates the corresponding virtual IP address on the VPN to the terminal within the site.

Further, the present embodiment has explained that the connection setting server part outputs the registration screen which displays the IP address obtained from the registration executing terminal as the registration target terminal, makes the user select the IP address of the registration executing terminal,

or makes the user select, as the registration target terminal, another terminal being different from the registration executing terminal, and makes the user enter the IP address of the another terminal.

Note that, in the above explanation, the VPN GW has been explained as an example of the relay device; however, the relay device according to the present invention is not limited to the VPN GW.

The present invention can be applied to the relay device which belongs to any of network segments of the internal network that is divided into a plurality of network segments, and the device relays the communication between the internal network and the external network.

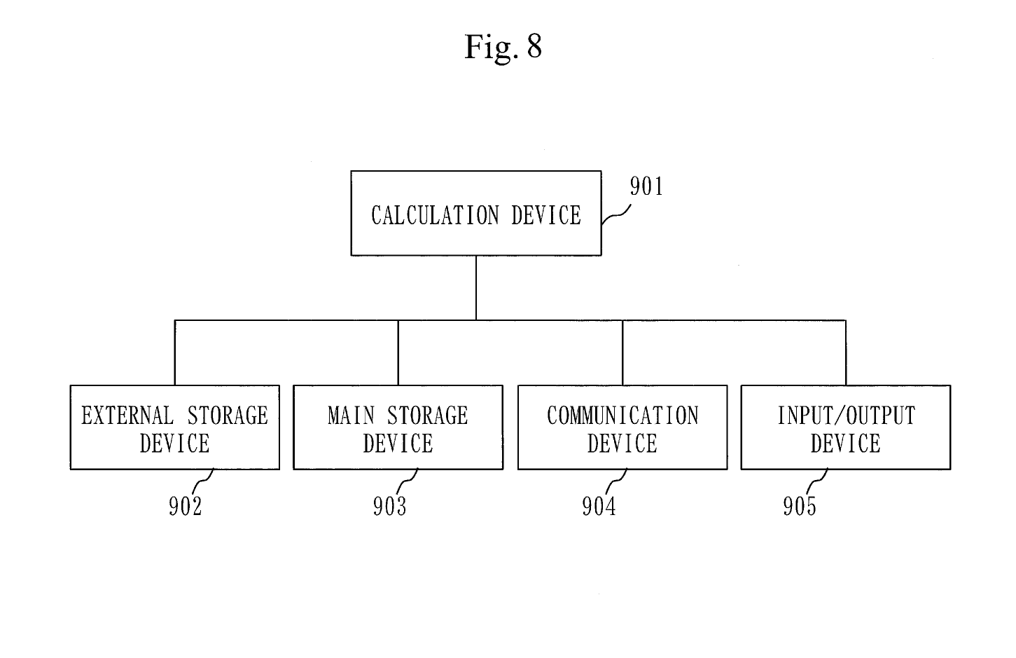

Finally, an example of the hardware configurations of the VPN GWs 11 and 12 described in the present embodiment will be explained with reference to FIG. 8. The VPN GWs 11 and 12 are computers; each component of the VPN GWs 11 and 12 can be implemented by programs.

As for the hardware configuration of the VPN GWs 11 and 12, a calculation device 901, an external storage device 902, a main storage device 903, a communication device 904, and an input/output device 905 are connected to a bus.

The calculation device 901 is a CPU (Central Processing Unit) which executes programs.

The external storage device 902 is, for instance, a ROM (Read Only Memory), a flash memory, and a hard disk drive.

The main storage device 903 is a RAM (Random Access Memory).

The communication device 904 corresponds to a physical layer of the LAN interface part 110.

The input/output device 905 is, for instance, an input key, a display device, and the like.

Programs are usually stored in the external storage device 902, and while being loaded to the main storage device 903, sequentially read and executed by the calculation device 901.

The programs are the programs to implement the function explained as a “part” illustrated in FIG. 2.

In addition, the external storage device 902 stores an operating system (OS), at least a part of the OS is loaded to the main storage device 903; while executing the OS, the calculation device 901 executes the programs implementing the function of the “part” illustrated in FIG. 2.

Further, information, data, signal values, or variable values representing a result of the processing of “determination”, “check”, “extraction”, “detection”, “setting”, “registration”, “selection”, “generation”, “input”, “output”, and the like discussed in the explanation of the present embodiment in the main storage device 903 as files.

Further, encryption keys, decryption keys, random number values, or parameters can be stored in the main storage device 903 as files.

Note that the configuration of FIG. 8 merely illustrates an example of the hardware configuration of the VPN GWs 11 and 12; the hardware configuration of the VPN GWs 11 and 12 is not limited to the configuration shown in FIG. 8, but can be another configuration.

Further, the terminal, the router, and the VPN server illustrated in the present embodiment may have the hardware configuration of FIG. 8, and also can have another hardware configuration.

Further, by the procedure illustrated in the present embodiment, a method for selecting communication method according to the present invention can be implemented.

### REFERENCE SIGNS LIST

1: site; 2: site; 3: management server; 11: VPN GW; 12: VPN GW; 21: router; 22: router; 31: terminal; 32: terminal; 33: terminal; 34: terminal; 41: VPN server; 110: LAN interface part; 120: VPN connection client part; 130: address/port conversion part; 140: tunneling connection part; 150: address checking part; 160: connection method setting part; 170: connection setting server part; 410: VPN connection management part; 420: VPN connection server part; and 430: virtual IP address assignment part.

1. A relay device which belongs to a network segment of an internal network that is divided into a plurality of network segments, and relays communication between the internal network and an external network being outside the internal network by conforming to a communication method selected from a plurality of communication methods, the relay device comprising:
an address notifying information receiving part to receive address notifying information, from one communication device belonging to the internal network, that notifies either of a communication address of the one communication device and a communication address of another communication device belonging to the internal network as a communication address of a selection target communication device that is a selection target of a communication method;
a segment checking part to check, based on the communication address of the selection target communication device and the communication address of the relay device, whether or not the selection target communication device belongs to a network segment being same with the relay device; and
a communication method selecting part to select, based on a checking result by the segment checking part, a communication method between the selection target communication device and the external network from the plurality of communication methods.

2. The relay device of claim 1, wherein
the segment checking part checks, in a case where the selection target communication device is determined not to belong to the network segment being same with the relay device, whether or not the selection target communication device is a communication device being a sender of the address notifying information.

3. The relay device of claim 1, wherein
the communication method selecting part selects, in a case where the selection target communication device is determined to belong to the network segment being same with the relay device by the segment checking part, as the communication method between the selection target communication device and the external network, a communication method according to which the relay device performs conversion of an IP (Internet Protocol) address described in a communication packet.

4. The relay device of claim 2, wherein
the communication method selecting part selects, in a case where the selection target communication device is determined to be the communication device being the sender of the address notifying information by the segment checking part, as the communication method between the selection target communication device and the external network, a communication method according to which the selection target communication device performs an encapsulation process of a communication packet.

5. The relay device of claim 2, wherein
the communication method selecting part selects, in a case where the selection target communication device is determined to be a communication device other than the communication device being the sender of the address notifying information by the segment checking part, as the communication method between the selection target communication device and the external network, a communication method according to which the relay device performs conversion of an IP (Internet Protocol) address and a port number described in a communication packet.

6. The relay device of claim 1, wherein
the relay device further comprises
a screen information sending part to send screen information for specifying a communication address of the selection target communication device to a communication device within the internal network, and
the address notifying information receiving part receives the address notifying information which notifies the communication address of the selection target communication device specified in the screen information.

7. The relay device of claim 1, wherein
the relay device is a VPN gateway device which sets a VPN (Virtual Private Network) between a communication device within the internal network and a communication device connected to the external network, and relays using the VPN communication between the communication device within the internal network and the communication device connected to the external network.

8. A method for selecting a communication method performed by a computer which belongs to a network segment of an internal network that is divided into a plurality of network segments, and relays communication between the internal network and an external network being outside the internal network by conforming to a communication method selected from a plurality of communication methods, the method for selecting the communication method comprising:
by the computer, receiving address notifying information, from one communication device belonging to the internal network, that notifies either of a communication address of the one communication device and a communication address of another communication device belonging to the internal network as a communication address of a selection target communication device that is a selection target of a communication method;
by the computer, checking, based on the communication address of the selection target communication device and the communication address of the computer, whether or not the selection target communication device belongs to a network segment being same with the computer; and
by the computer, selecting, based on a checking result, a communication method between the selection target communication device and the external network from the plurality of communication methods.

9. A program that causes a computer which belongs to a network segment of an internal network that is divided into a plurality of network segments, and relays communication between the internal network and an external network being outside the internal network by conforming to a communication method selected from a plurality of communication methods to execute:
an address notifying information receiving process receiving address notifying information, from one communication device belonging to the internal network, that notifies either of a communication address of the one communication device and a communication address of another communication device belonging to the internal network as a communication address of a selection target communication device that is a selection target of a communication method;
a segment checking process checking, based on the communication address of the selection target communication device and the communication address of the computer, whether or not the selection target communication device belongs to a network segment being same with the computer; and
a communication method selection process selecting, based on a checking result, a communication method between the selection target communication device and the external network from the plurality of communication methods.
